(19) United States
(12) Patent Application Publication
(10) Pub. No.: US 2015/0107154 A1
(43) Pub. Date: Apr. 23, 2015

(54) ASSEMBLY FOR CULTIVATING PLANTS

(71) Applicant: VIVI B.V., 'S-Gravendeel (NL)

(72) Inventor: Cornelis Frans Taco Visser, 'S-Gravendeel (NL)

(21) Appl. No.: 14/398,254

(22) PCT Filed: May 2, 2013
(86) PCT No.: PCT/NL2013/050333

§ 371 Date: Oct. 31, 2014

(30) Foreign Application Priority Data
May 3, 2012 (NL) 2008749

(51) Int. Cl. A01G 9/02

(52) U.S. Cl. CPC A01G 9/02
USPC 47/66.6

(57) ABSTRACT

An assembly for cultivating plants (17,18), in particular crops. Also, components of said assembly. The assembly comprises a fixedly disposed upright (5) which forms a suspension for a light source (6), and a cart (7) with a carrier (12) which is displaceable from and close to or even against the upright (5), and a container (13) for placing on or at the carrier (12) for the purpose of accommodating at least one plant (17,18). At least one of the upright (5), the light source (6), the cart (7), the carrier (12) and the container (13) may comprise a reflector and/or a light diffuser. Also, a heater with which disinfection is possible, preferably in a closed environment such as a cabin (1). Further, shaping of the upright (5) and the cart (7) for the most compact possible mutual engagement.

### CROSS-REFERENCE TO RELATED APPLICATIONS

The present application is a U.S. National Phase of International Application No. PCT/NL2013/050333, filed on May 2, 2013, designating the United States of America and claiming priority to NL 2008749, filed May 3, 2012. The present application claims priority to and the benefit of the above-identified applications, each of which is incorporated by reference herein in its entirety.

### TECHNICAL FIELD

The present invention relates to an assembly, a cart and a container for cultivating and/or growing plants, in particular agricultural crops.

### BACKGROUND

There are many systems and methods for cultivating and growing crops. Some of these have several of the features of the appended claims, in particular claim 1.

The known systems and methods all have the drawback that the development of the plants/crops is insufficiently predictable. There is after all a considerable distribution in the period of time which individual plants/crops require to reach full growth, or at least a stage in development at which the plants/crops can be released for merchandising and end consumers. Another drawback is that in the known systems and in the known methods highly inefficient use is still made of available space. In a greenhouse for instance a construction which is sometimes more than 6 metres high is sometimes erected in order to cultivate/grow/produce plants/crops (or at least the root systems thereof) at a single level. Solutions are known for operation under more laboratory-like conditions, in particular with artificial light. Here too use of space is still very inefficient. In the light of a growing world population there is a need for more efficient systems/methods for producing plants/crops for consumer use—as quickly and, in terms of use of space and associated costs, as efficiently as possible—for at least merchandising and preferably also consumption. No system/method is known to the inventors of the present invention which satisfies all these requirements.

### BRIEF SUMMARY

In order to satisfy as fully as possible current as well as future requirements and needs, or to at least partially already provide for these requirements and needs, there is provided according to the invention an assembly for cultivating plants, in particular crops, comprising: a fixedly disposed upright which forms a suspension for a light source; a cart with a carrier which is displaceable from and close to or even against the upright; and a container for placing on or at the carrier for the purpose of accommodating at least one plant.

### BRIEF DESCRIPTION OF THE DRAWINGS

FIG. 1 shows a perspective view of a partially cut-away cabin according to the present application;

FIG. 2 is a side view of a movable cart and a fixedly disposed upright;

FIG. 3 shows another side view of a single upright with a cart on either side;

FIG. 4 is a perspective view corresponding to FIG. 3;

FIGS. 5 and 6 show graphic representations of light distribution over a shelf-like carrier of a cart according to the present application;

FIG. 7 is a cross-sectional view of a detail of an assembly according to the present application;

FIG. 8 is a cross-sectional view corresponding to the view in FIG. 7, but of another embodiment according to the present application; and

FIG. 9 is a cross-sectional view of the embodiment of FIG. 8 during use.

### DETAILED DESCRIPTION

Various embodiments of the present application are drawn to an assembly for cultivating plants, in particular crops, comprising: a fixedly disposed upright which forms a suspension for a light source; a cart with a carrier which is displaceable from and close to or even against the upright; and a container for placing on or at the carrier for the purpose of accommodating at least one plant.

In a first non-exclusive embodiment the invention has the feature that at least one of the upright, the light source, the cart, the carrier and the container comprises a reflector and/or a diffuser.

The container can be manufactured for this purpose from plastic with a light colour, for instance white, in order to form the reflector. Additionally or alternatively, a reflective layer can be arranged on or against an inner surface of the container.

Provided in another embodiment is a heater with which disinfection is possible, preferably in a closed environment such as a cabin. Another embodiment further relates to the design of the upright and of the cart for the most compact possible mutual engagement.

Additionally or alternatively, the container can comprise a closing element such as a film or a cover, which closing element is substantially transparent and is configured to scatter light passing therethrough in order to form the light diffuser. The closing element can here be air-permeable and/or vapour-permeable substantially in a direction out of the container. Additionally or alternatively, the container can be manufactured from plastic with a light colour, for instance milk white, in order to form the light diffuser when light is reflected against inner walls of the container.

Using all these embodiments of the present invention the distance between the light source and the container, or at least the plants/crops in the container, can be reduced in order to achieve an improved efficiency, at least in respect of use of space.

Additionally or alternatively, inner walls of the container can be reflective and the inner walls can comprise roughened portions for the purpose of forming the diffuser. This is an elegant, simple and favourable embodiment for bringing about both reflection and scattering of light.

Additionally or alternatively, the assembly further comprises a housing which defines a closable cabin having therein at least the upright and further, during use, the cart. The housing can thus form as it were a storage and a protection for plants during cultivation and/or growth thereof. Harmful influences can be more easily excluded from a cabin than for instance from a greenhouse. A cabin can moreover define a closed environment for the containers, and more particularly the plants therein. Particularly when the containers are even closed or closable, it is possible to suffice with a relatively very low air humidity in the interior of the cabin, since it is the humidity in the closed or closable containers which determines the growth and development of the plants therein. Since the interior of the cabin can then be relatively dry, transmission of pathogens between containers is significantly reduced.

Additionally or alternatively, the upright can comprise a heater. A heating element can be integrated here into the upright. A simple configuration can thus be realized compared to a construction with separate heating elements. Particularly in a cabin the heater can be configured, when the assembly for cultivation or growth of plants is not in use, to increase the temperature thereof or therein for a predetermined period of time, for instance at least one hour, to a minimum value for disinfection, for instance at least 60 [deg.] C., and preferably about 70 [deg.] C. The cabin can thus be disinfected in simple manner following a predetermined period of use for cultivating or growing plants and, following disinfection, can then be taken into use again for cultivation or growth. A cycle of use of the cabin can thus be realized, wherein growth or cultivation is alternated with disinfection by the heater (which is preferably integrated, though not in every embodiment of the invention).

Additionally or alternatively, the upright can define a central plane, wherein at least one light source is arranged on each side of the central plane. It is thus further possible to dispose a cart on each side of the upright so as to enable efficient use of for instance floor area available in a cabin. In order to increase still further the efficiency and the use of space in a variant with a heater, the heater can be disposed here in the central plane.

Additionally or alternatively, the cart can comprise a back construction and the carrier of the cart for receiving the container thereat or thereon can extend from the back construction during use toward a or the central plane of the upright and under the light source. In an embodiment with a plurality of light sources one above the other on the upright the cart can thus be moved with the carrier(s) therebetween in order to realize a mutually fitting configuration with small distances between the light sources and the containers, or at least the plants therein. Additionally or alternatively, the assembly can further comprise: at least two carriers on the back construction on mutually opposite sides relative to the back construction. Carts with carriers on either side can thus be wheeled or otherwise moved between fixedly disposed uprights in order to realize an extremely compact configuration.

Additionally or alternatively, a dosed quantity of liquid, in particular water with optional nutrient additives, can be arranged in the container during use. This contributes particularly toward the feature that containers can be introduced into the assembly with just planted seeds, seedlings or other young plants and can remain in the assembly until a development of the plants has taken place that is suitable for merchandising or consumption. The containers can then even be dispatched without transplanting the plants to other containers. In determining the quantity of water it is even possible here to take this transport into account, and to optionally also take into account a period in which the plants may be offered for sale in an arrangement in a shop or garden centre or other location.

Additionally or alternatively, the dosed quantity of liquid can be arranged in a reservoir in the container. Providing a reservoir in the interior of the container may make it necessary to arrange a dosing medium such as a wick or lamella with capillary suction action in order to feed the water in dosed measure to the plants/crops. The most important consideration in providing a reservoir is that a desired quantity of water or other moisture is reserved for use over time by the plants in the container.

Additionally or alternatively, the container can be dimensioned to accommodate plants which are fully grown or at least sufficiently developed for merchandising, and a closing element such as a film or a cover is arranged during use above or over or on the container for substantially the whole period of time the container remains at the upright. It is here also the case that, with highly predictable growth and development of plants and crops in the container, which is closed or at least closable, the plants can remain in the container from the earliest stage of development until a stage of growth suitable for merchandising or consumption.

An embodiment of the present invention will be described hereinbelow with reference to the accompanying drawing in which the same or similar reference numerals may be used for the same or similar parts, components and aspects. The drawing shows an embodiment, wherein it should be noted that alternatives are likewise possible within the scope of protection as defined in the appended claims.

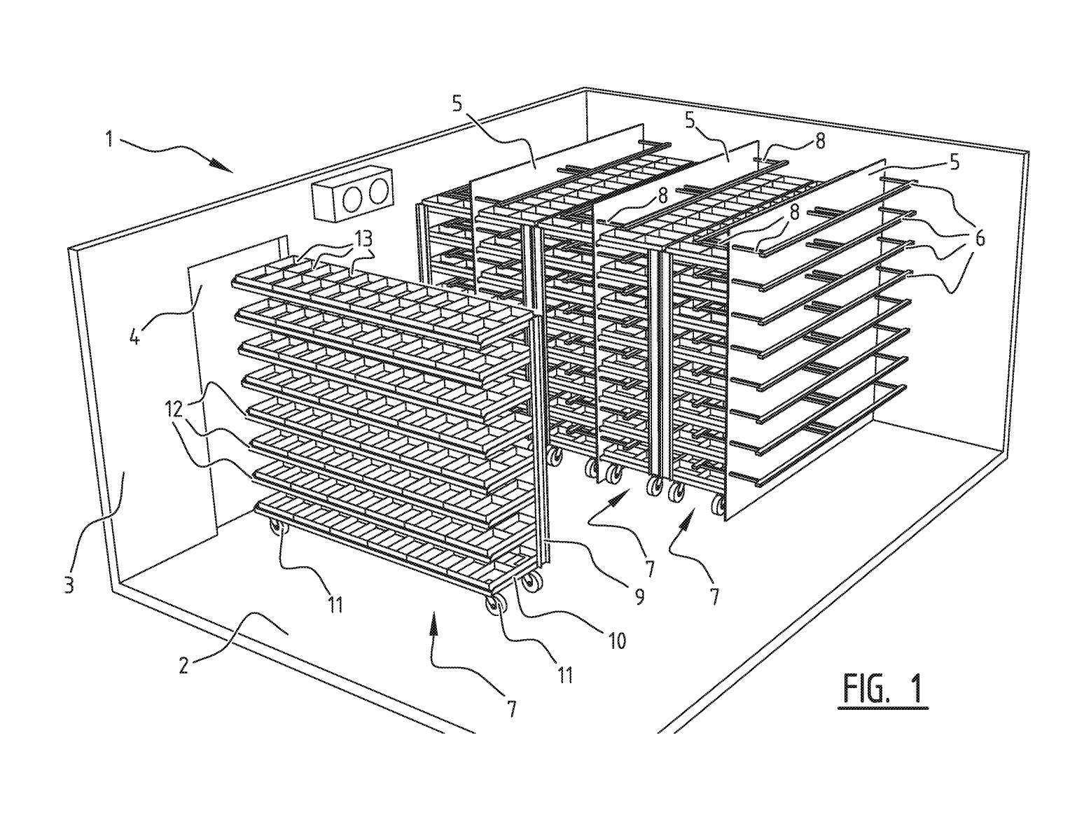

FIG. 1 shows a cabin 1 with a floor 2 and walls 3 with a door 4 or other passage in at least one of the walls 3. Although a ceiling and several of the walls 3 are not shown, cabin 1 forms a closed unit.

Uprights 5 are fixedly disposed in the space defined by cabin 1. Uprights 5 are plate-like and preferably connected to a heating system to enable regulation of the temperature in cabin 1. In such an embodiment the uprights 5 are for instance hollow for the purpose of throughflow with a heat transfer medium. Additionally or alternatively, electrical heating means, which can be connected to an electrical power supply, can be arranged in or on the plate-like uprights 5, likewise to enable regulation of the temperature in cabin 1.

Uprights 5 can be of the type as mainly known from O-00/08922 and/or WO-2009/014422. As known from said publications, such uprights can be utilized for heating, cooling and air distribution. In a use as heating/cooling a highly accurate temperature setting is moreover possible with such uprights. Light reflective and/or scattering covering can be arranged on or at uprights 5, for instance in the form of a coating and/or lacquer and/or a layer applied in other manner. In combination with a very high density of plants as a result of the scattering and/or reflection, the high temperature accuracy in combination with the high light density and favourable light distribution results in a very favourable assembly in terms of cost. Considerable energy savings can be achieved here compared to other cultivation and growth cells, very precise control of temperature and supplied light is possible, and possibilities and optimizations are therefore created which have not been previously implemented and which even seemed impossible.

Using the uprights 5 forming a heater the temperature in cabin 1 can preferably be increased to a temperature in cabin 1 suitable for disinfection, for instance 60 [deg.] C. or more preferably 70 [deg.] C. The temperature in cabin 1 can preferably be held for a predetermined period of time at this level in order to disinfect the space in cabin 1. Carts can optionally be arranged here in the space of cabin 1 in order to also disinfect these carts 7.

Arranged on either side of uprights 5 are arms 8 which bear light fittings 6. Light fittings 6 can be formed as profiles with LED light sources therein. When LED light sources are used, the wavelength or the frequency of the light can usually be chosen or set accurately. A choice for a determined frequency of the light or wavelength thereof can for instance result from selecting a specific type of LED lamp. The selection of a wavelength of the light from the light sources can also depend on the type of plant or crop being cultivated in the cabin.

Reference has already been made above to carts 7. In FIG. 1 a single cart 7 is shown at door 4. Other carts 7 are disposed at each of the uprights 5. Cart 7 comprises a base 10 which can travel on wheels 11 and on which a back construction 9 is arranged. Back construction 9 serves as mounting for a number of shelf-like carriers 12 on which tray-like containers 13 are placed or at least can be placed.

In the configuration shown in FIG. 1 the cart 7 comprises eight shelf-like carriers, the lowest of which forms the base 10. The shelf-like carriers 12 are arranged on back construction 9 at short mutual distances from each other in the vertical direction, and an open space is present between adjacent shelf-like carriers 12 on the side opposite back construction 9.

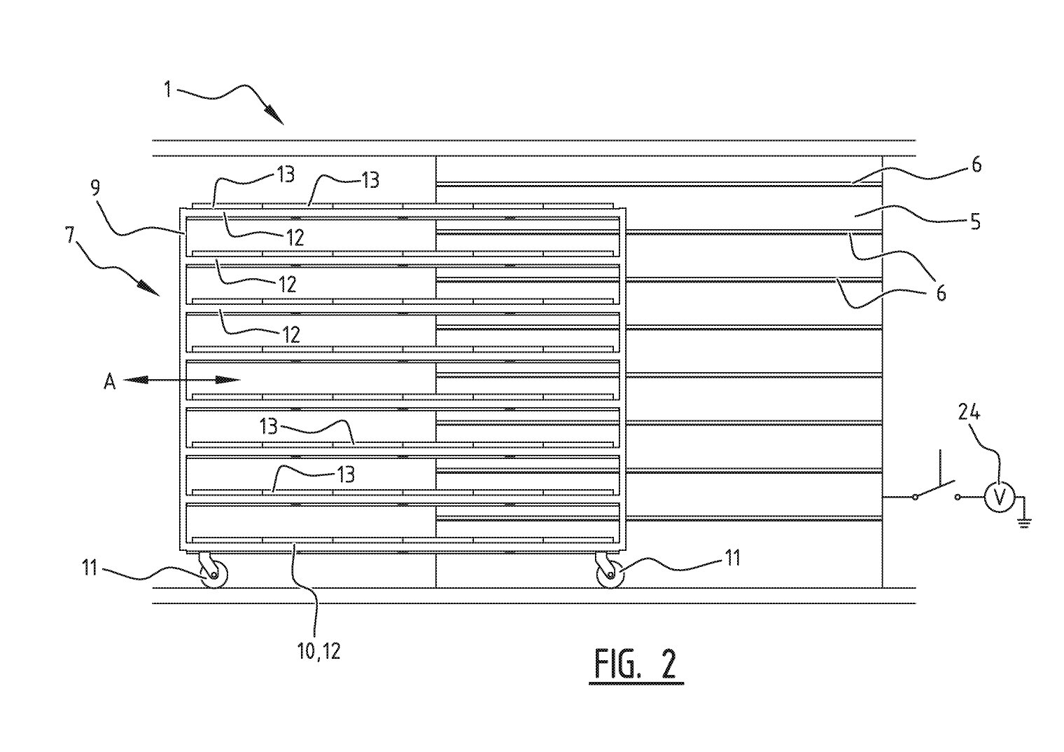

FIG. 2 shows how a mobile cart 7 is movable in the direction of double arrow A in order to carry the containers 13 a short distance below light sources 6. It will be immediately apparent that a highly efficient use of space is achieved. Light sources 6 are a very short distance above the containers 13 disposed on, in or at the shelf-like carriers 12. The manner in which mobile cart 7 is displaceable in the direction of double arrow A also contributes toward the highly effective use of space, since a highly compact arrangement can thus be realized as shown in FIG. 1 for the uprights 5 on the left and in the middle, with a full complement of carts 7 between uprights 5 and with no intermediate space.

It is noted that carts 7 can also be embodied in a manner wherein shelf-like carriers 12 extend in both directions from the back construction. In such an embodiment two separate carts 7 are not placed between two adjacent uprights 5, for it is possible to suffice with a single cart 7 with shelf-like carriers 12 extending in both directions from back construction 9. Reference is only made here to such an embodiment; it is not shown in the accompanying drawing. Reference is further made here to the possibility of arranging light sources 6 on carts 7. An electrical connection can be made here by a user between a cart 7 and an upright 5—for instance with a plug in a socket outlet in the cabin or on the upright, or rapid-action couplings can be applied. With this latter option of rapid-action couplings an additional measure is also provided to enable the cart to be placed correctly and predictably at a desired position relative to the upright, since otherwise the light will simply not come on.

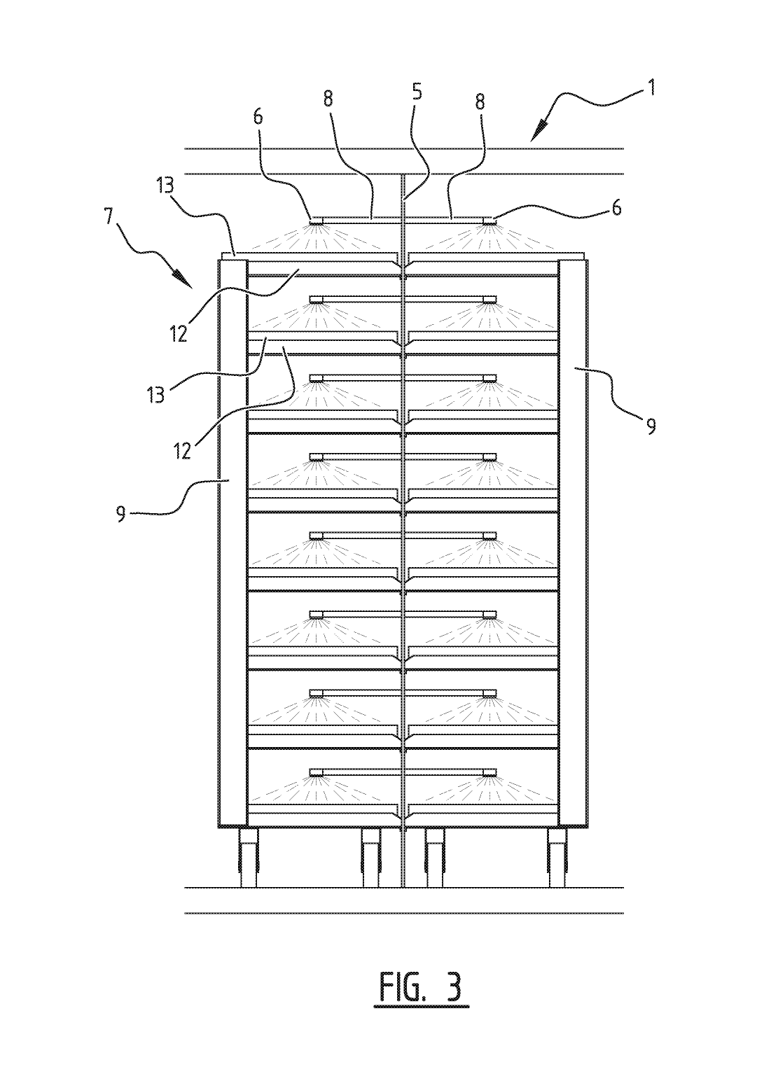

FIG. 3 shows an end view of a single upright 5 with light sources 6 on arms 8 against which two carts 7 are placed, wherein the free edges of shelf-like carriers 12 lie closely against uprights 5 in order to realize the most compact possible configuration. It is noted that light sources 6 have quite a wide angle of emission as shown schematically in FIG. 3 with broken lines. Light sources 6 can be fluorescent lamps, or more preferably LED light sources. Reflectors can be incorporated in the fittings thereof in order to realize the shown wide angle of emission.

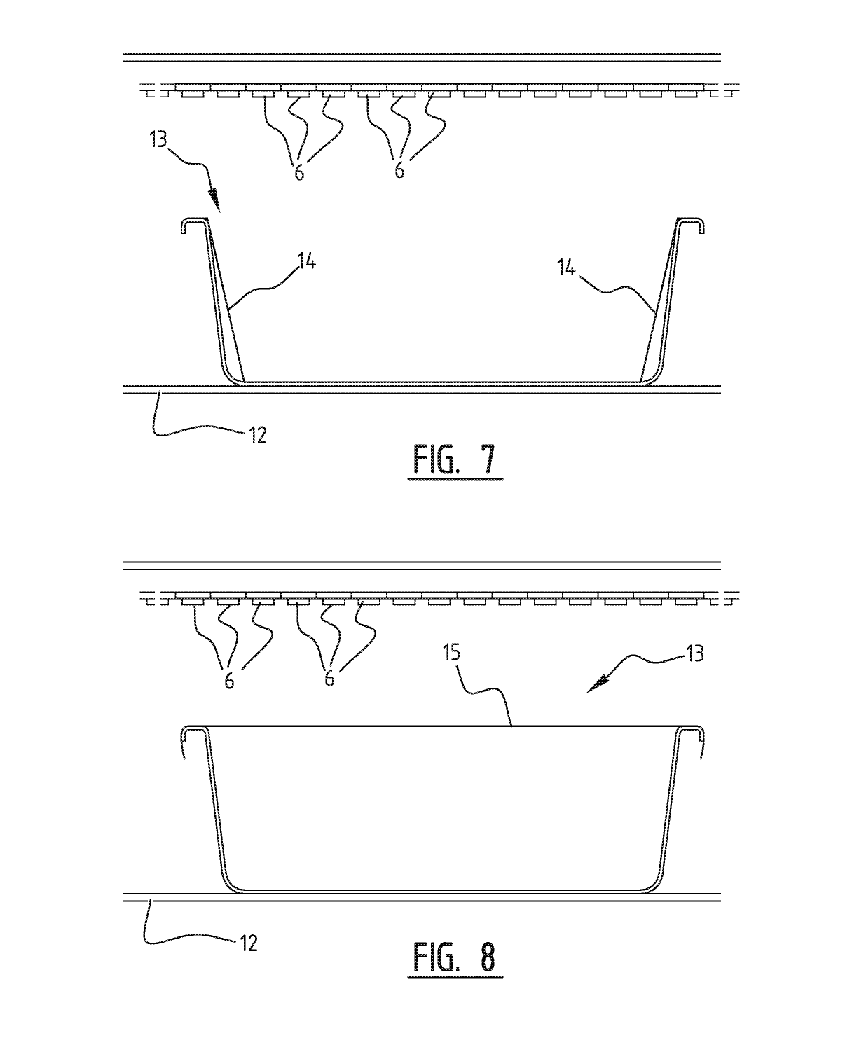

It has however been found that, particularly at the level of containers 13 or more particularly the plants (not shown) therein, a strongly varying light intensity results if a considerable distance is not provided between the plants (not shown) in containers 13 and light sources 6. In order to nevertheless provide the most compact possible configuration such as that in FIGS. 1, 2 and 3, additional measures are provided according to the present invention, particularly at the level of containers 13 and/or the plants (not shown) therein. FIG. 7 in particular shows an embodiment enabling a short distance between light sources 6 and containers 13. In the embodiment of FIG. 7 a layer 14 of reflective and scattering material is arranged, whereby light from light sources 6 is reflected and scattered. It is also possible to dispense with the separately arranged layer 14 by forming container 13 from white or milk white plastic, so that the degree of reflection and scattering can be realized without the additional or reflective or scattering layer 14.

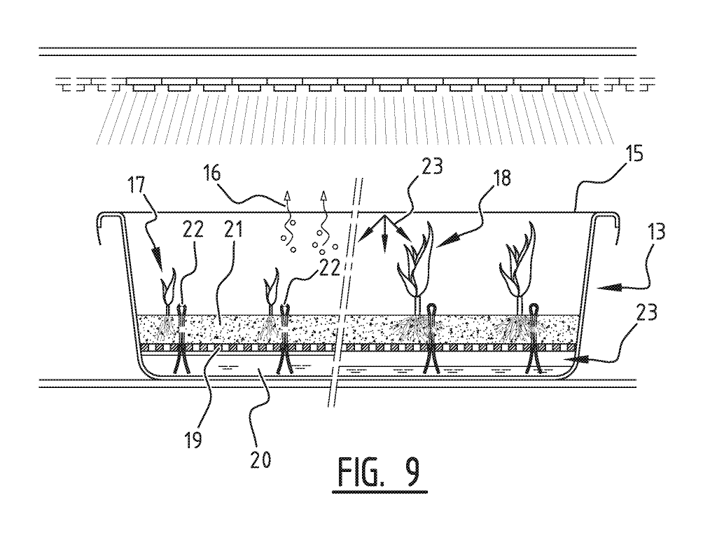

In the embodiment of FIG. 8 use is made of a vapour-permeable film 15 which closes off container 13 from the immediate surrounding area. The vapour-permeable film 13 is chosen such that vapour 16 in FIG. 9 from plants 17, 18 can be allowed through at different stages of development in accordance with the consumption of water or other moisture by said plants 17, 18 at various stages of development. A bottom 19 can be arranged for this purpose in container 13 having thereunder a predetermined quantity of water 20 or other moisture, possibly with additives such as nutrients. Arranged thereabove is a substrate 21 in which young plants can be planted or seeds can be laid before film 15 is arranged. Also prearranged in the substrate are strings, wicks, lamellas or other similar components 22 which have a moisture-transmitting function, for instance on the basis of a capillary action thereof. Water 20 can thus be transported out of the reservoir 23 formed below the bottom 19 to roots of the plants 17, 18 at various stages of development.

It is in this way possible to allow plants to develop in a single container 13, without transplantation thereof, until plants 17, 18 at different stages of development have reached a development sufficient for merchandising or for consumption. As soon as plants 17, 18 in a container 13 have reached such a development, a cart 7 with containers 13 can be taken out of the assembly of for instance FIG. 1, 2 or 3 for dispatch of containers 13.

Film 15 otherwise has light-scattering properties, this being designated schematically with arrows 23 extending in all directions. It is thus possible to ensure that all of the plants 17, 18 in container 13 receive sufficient light for the period they remain in the assembly as shown in FIG. 1, 2 or 3.

Optionally in combination with other measures, such as a reflective and scattering layer on the inner surface of the walls of container 13, but also individually, the distance between light sources 6 and plants 17, 18 in container 13 can thus be minimized. A highly efficient use of space is thus possible, while the light distribution profiles of FIGS. 5 and 6 indicate that the light distribution of light sources 6 can be made almost homogenous over the upper surface of substrate 21 in container 13, for instance in FIG. 9.

For the purpose of reflection and scattering of light from light sources 6 the carts 7 and uprights 5 can be provided with a white coating, for instance a lacquer coating or a powder coating, or a mirror layer of aluminium or the like. FIG. 5 shows the light distribution without reflective and/or scattering measures and, when compared to FIG. 6 which relates to a measurement where such reflective and scattering measures have been implemented, demonstrates that the light distribution is considerably more homogenous than in FIG. 5, this enhancing the development and growth of plants at every position in a container 13.

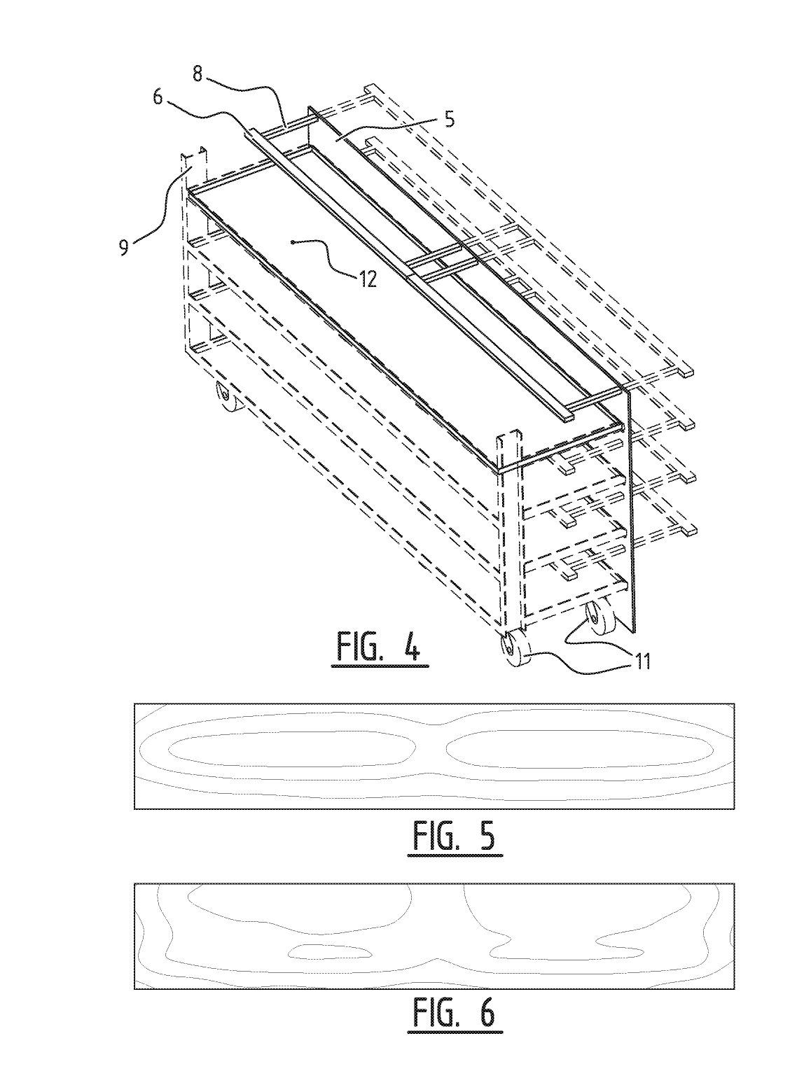

A reflective layer 14 is arranged in the embodiment of FIG. 7. This can define a roughened surface in order to also optimize the scattering. It will be immediately apparent that many additional and alternative embodiments are possible within the context of the present invention without departing from the scope of protection defined for the invention in accordance with the claims, and in particular the independent claim. The heater in FIG. 2 is thus integrated into upright 5 in an embodiment of an electrical heater which can be connected selectively to a voltage source 24, although upright 5 can also comprise liquid channels for passage therethrough of a heat transfer medium. Carts can be displaced in the direction of double arrow A in FIG. 2, but it is likewise possible to displace carts from and to the uprights 5 in a direction substantially perpendicularly of the front surface of upright 5 (although this will in all likelihood entail a reduction in the effective use of space, but is nevertheless not precluded from the scope of protection of the present invention). Reference is made in the foregoing to LED light sources 6, although the present invention is not limited thereto, since more conventional sources can be applied or future sources not yet available may perhaps produce even better results. In the embodiment of FIGS. 1, 2, 3 and 4 shelf-like holders 12 extend in each case in one direction from a back construction 19, but shelf-like holders 12 can also be arranged in the opposite direction. In such an embodiment a single cart with shelf-like holders 12 extending in two directions from a back construction 9 can be moved between the two adjacent uprights 5 with light sources 6 thereon. FIG. 7 shows an open container 13, while in FIG. 8 a film for vapour passage and scattering of light is arranged in order to close the container 13. Additionally or alternatively, a cover can further be provided to temporarily close container 13 more completely, for instance during transport. In the embodiment of FIG. 8 the invention in any case already has the advantage that the air humidity in a cabin 1 can be kept considerably lower than the air humidity required in the interior of a closed container 13 to allow development of plants. The relatively low air humidity in the cabin compared to that in the interior of a closed container 13 minimizes transmission of pathogens through the cabin. Containers 13 remain in the assembly with the cart and the upright in cabin 1 until plants in containers 13 have reached a sufficient development for merchandising or final consumption. Only then is cart 7 taken out of the assembly and the holders can be dispatched without transplanting being necessary. Additionally or alternatively, it is of course possible to take the plants 17, 18 out of containers 13 and transplant them to other containers before they are dispatched. It is important to note that the present invention makes it possible, while not being limited thereto, to cultivate and allow plants to develop in highly reproducible manner while they can remain for the whole time duration hereof in the assembly.

1. An assembly for cultivating plants comprising:
a fixedly disposed upright which forms a suspension for a light source;
a cart with a carrier which is displaceable from and close to or against the upright; and
a container configured to be placed on or at the carrier and to accommodate at least one plant.

2. The assembly as claimed in claim 1, wherein at least one selected from the group consisting of the upright, the light source, the cart, the carrier and the container comprises a reflector.

3. The assembly as claimed in claim 2, wherein the container is manufactured from a light colour plastic capable of acting as the reflector.

4. The assembly as claimed in claim 2, wherein a reflective layer is arranged in, on or against an inner surface of the container.

5. The assembly as claimed in claim 1, wherein at least one selected from the group consisting of the upright, the light source, the cart, the carrier and the container comprises a light diffuser.

6. The assembly as claimed in claim 5, wherein the container comprises a substantially transparent closing element configured to scatter light passing therethrough.

7. The assembly as claimed in claim 6, wherein the closing element is air-permeable, vapour-permeable, or a combination thereof substantially in a direction out of the container.

8. The assembly as claimed in claim 5, wherein the container is manufactured from a light colour plastic which is capable of acting as the light diffuser when light is reflected against inner walls of the container.

9. The assembly as claimed in claim 5, wherein inner walls of the container are reflective and roughened portions configured to form the diffuser.

10. The assembly as claimed in claim 1, further comprising:
a housing which defines a closable cabin having therein at least the upright and further, during use, the cart.

11. The assembly as claimed in claim 1, further comprising a heater.

12. The assembly as claimed in claim 11, wherein a heating element is integrated into the upright.

13. The assembly as claimed in claim 11, wherein the heater is configured to increase the temperature thereof or therein for a predetermined period of time to a minimum value for disinfection when the assembly is not in use.

14. The assembly as claimed in claim 1, wherein the upright defines a central plane, wherein at least one light source is arranged on each side of the central plane.

15. The assembly as claimed in claim 14, further comprising a heater disposed in the central plane.

16. The assembly as claimed in claim 1, wherein the cart comprises a back construction, and the carrier of the cart is configured to extend from the back construction, during use, toward a central plane of the upright defined by the upright and under the light source.

17. The assembly as claimed in claim 16, further comprising at least two carriers on the back construction of the cart on mutually opposite sides relative to the back construction.

18. The assembly as claimed in claim 16, further comprising at least two carriers on the back construction of the cart above or below each other on the same side relative to the back construction.

19. The assembly as claimed in claim 1, wherein a dosed quantity of liquid is arranged in the container during use.

20. The assembly as claimed in claim 19, wherein the dosed quantity of liquid is arranged in a reservoir in the container.

21. The assembly as claimed in claim 19, wherein the container is dimensioned to accommodate plants which are fully grown or at least sufficiently developed for merchandising, and a closing element is arranged, during use, above, over or on the container for substantially a whole period of time the container remains at the upright.
